(19) United States
(12) Patent Application Publication
(10) Pub. No.: US 2012/0286449 A1
(43) Pub. Date: Nov. 15, 2012

(54) CASTABLE POLYURETHANE COVERS BASED ON ISOCYANATE BLENDS FOR GOLF BALLS

(76) Inventors: Michael Michalewich, Mansfield, MA (US); Shawn Ricci, New Bedford, MA (US); Brian Comeau, Berkley, MA (US)

(21) Appl. No.: 13/534,264

(22) Filed: Jun. 27, 2012

Related U.S. Application Data
(63) Continuation-in-part of application No. 13/340,576, filed on Dec. 29, 2011.
Application No. 13/340,576 is a continuation-in-part of application No. 12/697,359, filed on Feb. 1, 2010.

(51) Int. Cl. B29C 39/10

(52) U.S. Cl. 264/279

(57) ABSTRACT

A method for making a golf ball having a cover material comprising a polyurethane or polyurea composition is provided. The composition is prepared from a reactive mixture of a polyurethane or polyurea prepolymer and curative blend, wherein the blend comprises: i) a curing agent, ii) a freezing point depressing agent; and iii) pigment. The composition is cast over a ball subassembly to form the cover. The resulting cover material has many advantages including improved thermal-stability, light-stability, durability, toughness, and cut/tear-resistance. The preferred isocyanates in the blend include isophorone diisocyanate (“IPDI”); 1,6-hexamethylene diisocyanate (“HDI”); 4,4′-dicyclohexylmethane diisocyanate (“H₁₂ MDI”); 4,4′-diphenylmethane diisocyanate (4,4′-MDI); toluene diisocyanate (“TDI”); and homopolymers and copolymers thereof.

### CROSS-REFERENCE TO RELATED APPLICATIONS

This application is a continuation-in-part of co-pending, co-assigned U.S. patent application Ser. No. 13/340,576 filed Dec. 29, 2011, which is a continuation-in-part of co-pending, co-assigned U.S. patent application Ser. No. 12/697,359 filed Feb. 1, 2010, the entire disclosures of which are hereby incorporated by reference.

### BACKGROUND OF THE INVENTION

1. Field of the Invention

The present invention relates generally to methods for making a golf ball having a cover material made from a polyurethane or polyurea composition and the resulting ball. The composition is produced using certain isocyanate blends and curatives containing freezing point depressants. The cover material has many advantages including improved thermal-stability, durability, toughness, and cut/tear-resistance.

2. Brief Review of the Related Art

Multi-piece solid golf balls having an inner core and outer cover with an intermediate layer disposed there between are popular today in the golf industry. The inner core is made commonly of a rubber material such as natural and synthetic rubbers, styrene butadiene, polybutadiene, poly(cis-isoprene), or poly(trans-isoprene). Often, the intermediate layer is made of an ethylene-based acid copolymer ionomer resin that helps impart hardness to the ball. Metal ions such as sodium, lithium, zinc, and magnesium are used to neutralize the acid groups in the copolymer. The outer cover of conventional golf balls are made from a variety of materials including ethylene-based acid copolymer ionomers, polyamides, polyesters, and thermoplastic and thermoset polyurethane and polyurea elastomers.

In recent years, there has been high interest in using polyurethanes and polyurea compositions to make core, intermediate, and/or cover layers for the golf balls. Basically, polyurethane compositions contain urethane linkages formed by the reaction of a multi-functional isocyanate (NCO—R—NCO) with a long-chain polyol having terminal hydroxyl groups (OH—OH) in the presence of a catalyst and other additives. The chain length of the polyurethane prepolymer is extended by reacting it with a hydroxyl-terminated curing agent. Polyurea compositions, which are distinct from the above-described polyurethanes, also can be formed. In general, polyurea compositions contain urea linkages formed by reacting an isocyanate group (—N═C═O) with an amine group (NH or NH₂). The chain length of the polyurea prepolymer is extended by reacting the prepolymer with an amine curing agent. Hybrid compositions containing urethane and urea linkages also may be produced. For example, when a polyurethane prepolymer is reacted with amine-terminated curing agents during the chain-extending step, any excess isocyanate groups in the prepolymer will react with the amine groups in the curing agent. The resulting polyurethane composition contains urethane and urea linkages and may be referred to as a hybrid. In another example, a hybrid composition may be produced when a polyurea prepolymer is reacted with a hydroxyl-terminated curing agent.

Golf ball covers made from polyurethane and polyurea compositions are generally known in the industry. In recent years, polyurethane and polyurea cover materials have become more popular, because they provide the golf ball covers with a desirable combination of “hard” and “soft” features. The relative hardness of the cover protects the ball from being cut, abraded, and otherwise damaged. In addition, such harder-covered golf balls generally reach a higher velocity when struck by a club. As a result, such golf balls tend to travel a greater distance, which is particularly important for driver shots off the tee. Meanwhile, the relative softness of the cover provides the player with a better “feel” when he/she strikes the ball with the club face. The player senses more control over the ball as the club face makes impact. Such softer-covered balls tend to have better playability. The softer cover allows players to place a spin on the ball and better control its flight pattern. This is particularly important for approach shots near the green. Polyurethane and polyurea covered golf balls are described in the patent literature, for example, U.S. Pat. Nos. 5,334,673; 5,484,870; 6,476,176; 6,506,851; 6,867,279; 6,958,379; 6,960,630; 6,964,621; 7,041,769; 7,105,623; 7,131,915; and 7,186,777.

As discussed above, isocyanates with two or more functional groups are essential components in producing polyurethane and polyurea polymers. These isocyanate materials can be referred to as multi-functional isocyanates. Such isocyanates can be referred to as monomers or monomeric units, because they can be polymerized to produce polymeric isocyanates containing two or more monomeric isocyanate repeat units.

Aromatic isocyanates are normally used for several reasons including their high reactivity and cost benefits. Examples of conventional aromatic isocyanates include, but are not limited to, toluene 2,4-diisocyanate (TDI), toluene 2,6-diisocyanate (TDI), 4,4′-methylene diphenyl diisocyanate (MDI), 2,4′-methylene diphenyl diisocyanate (MDI), polymeric methylene diphenyl diisocyanate (PMDI), p-phenylene diisocyanate (PDI), m-phenylene diisocyanate (PDI), naphthalene 1,5-diisocynate (NDI), naphthalene 2,4-diisocyanate (NDI), p-xylene diisocyanate (XDI), and homopolymers and copolymers thereof. The aromatic isocyanates are able to react with the hydroxyl or amine compounds and form a durable and tough polymer having a high melting point. The resulting polyurethane or polyurea material generally has good mechanical strength and cut/shear resistance. However, one disadvantage with using aromatic isocyanates is the polymeric reaction product tends to have poor light stability and may discolor upon exposure to light, particularly ultraviolet (UV) light. Because aromatic isocyanates are used as a reactant, some aromatic structures may be found in the reaction product. UV light rays can cause quinoidation of the benzene rings resulting in yellow discoloration. Hence, UV light stabilizers are commonly added to the formulation, but the covers may still develop a yellowish appearance over prolonged exposure to sunlight. Thus, golf balls are normally painted with a white paint and then covered with a transparent coating to protect the ball's appearance.

In a second approach, aliphatic isocyanates are used to form the prepolymer. Examples of aliphatic isocyanates include, but are not limited to, isophorone diisocyanate (IPDI), 1,6-hexamethylene diisocyanate (HDI), 4,4′-dicyclohexylmethane diisocyanate (“H₁₂ MDI”), and homopolymers and copolymers thereof. These aliphatic isocyanates can provide polyurethane and polyurea materials having generally good light stability but such polymers tend to have reduced mechanical strength and cut/shear-resistance.

As discussed above, golf ball covers having good light stability are needed. One objective of this invention is to develop a golf ball cover having good light stability that does not sacrifice important mechanical properties such as high tensile strength and cut/tear-resistance. It is also desirable that the golf ball cover be made of a tough and durable material that can withstand high temperatures for significant periods of time. Another objective of this invention is to develop a golf ball having high thermal stability. When a polyurethane or polyurea composition is used as the cover material, the properties of the composition depend in significant part upon the components or building blocks used to make the composition, particularly the isocyanates, polyols, polyamines, and curing agents. It would be beneficial to develop isocyanate blends that could provide the polyurethane and polyurea compositions with such desirable properties as high tensile strength, impact durability, cut/tear-resistance, light stability, and thermal stability. One objective of this invention is to develop such isocyanate blends. The present invention provides golf ball cover materials having such characteristics as well as other advantageous properties, features, and benefits.

### SUMMARY OF THE INVENTION

The present invention relates to methods for making multi-piece golf balls having a cover layer made from a polyurethane or polyurea composition and methods for making such balls. In one embodiment, the ball is a two-piece ball having an inner core comprising polybutadiene and an outer cover layer comprising the polyurethane or polyurea composition. The cover layer may have a thickness of about 0.015 to about 0.090 inches and material hardness in the range of about 40 to about 65 Shore D. In another embodiment, a three-piece ball containing an inner core, intermediate layer disposed about the core, and an outer cover layer comprising a polyurethane or polyurea composition may be made. The intermediate layer may comprise an ethylene acid copolymer ionomer resin and may have a thickness of 0.015 to 0.120 inches and a surface hardness in the range of 45 to 75 Shore D. Four-piece balls having a multi-layered core and multi-layered cover also may be made.

Methods for manufacturing multi-piece balls are also included. In one preferred version, the method involves the steps of: i) providing a golf ball subassembly such as a core or a core with at least one intermediate layer disposed about the core; ii) providing a castable composition comprising a reactive mixture of polyurethane or polyurea prepolymer and curative blend, wherein the blend comprises a curing agent, freezing point depressing agent, and pigment; and iii) forming a cover layer over the golf ball subassembly by providing first and second mold cavities, dispensing the castable composition into at least one mold cavity, positioning the core in one mold cavity, and mating the mold cavities together.

As mentioned above, the curative blend includes a freezing point depressing agent so that the freezing point of the blend is less than its normal freezing point temperature. Since the modified curative blend resists freezing, the pigments contained in the blend tend to remain in dispersed form and do not form agglomerates or aggregates. The modified curative blend contains a storage-stable dispersion of pigment. This helps produce a more homogeneous polyurethane or polyurea composition. In the finished balls, the polyurethane and polyurea cover materials provide many desirable properties. For example, the balls have good mechanical strength and cut/shear-resistance as well as light-stability and overall weatherability.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is a front view of a dimpled golf ball made in accordance with the present invention;

FIG. 2 is a cross-sectional view of a two-piece golf ball having a cover made in accordance with the present invention;

FIG. 3 is a cross-sectional view of a three-piece golf ball having a cover made in accordance with the present invention;

FIG. 4 is a cross-sectional view of a four-piece golf ball having a multi-layered core and a cover layer made in accordance with the present invention;

FIG. 5 is a cross-sectional view of a four-piece golf ball having a multi-layered cover made in accordance with the present invention; and

FIG. 6 is a perspective view of one embodiment of upper and lower mold cavities that can be used to make a golf ball in accordance with the present invention.

### DETAILED DESCRIPTION OF THE PREFERRED EMBODIMENTS

The present invention relates to golf balls having a cover made from a polyurethane, polyurea, or hybrid of polyurethane and polyurea composition. As discussed further below, the composition is prepared from a reactive mixture of a polyurethane or polyurea prepolymer and curative blend, wherein the blend comprises: i) a curing agent, ii) a freezing point depressing agent; and iii) pigment. The composition is cast over a ball subassembly to form the cover.

Isocyanate Compounds

As discussed above, polyurethane and polyurea compositions are generally elastomeric materials that are the reaction product of isocyanate compounds and polyols or polyamines. There are many isocyanate compounds known in the art. In the present invention, it is important that the isocyanates provide the composition with sufficient thermal stability so that it can withstand high temperatures. The composition must have high mechanical integrity so that it does not melt or soften easily. That is, the composition must have some relatively stiff characteristics. At the same time, it is important that the composition is not overly stiff and inflexible. The composition needs to be elastomeric and have sufficient resiliency. This elastomeric nature will help provide the composition with higher cut/tear-resistance and tensile strength. Surprisingly, it has been found that the following blends of isocyanate compounds provide the resulting polyurethane and polyurea compositions with an optimum combination of properties:
a) 65 to 45 wt. % of isophorone diisocyanate (“IPDI”) and 35 to 55 wt. % of 1,6-hexamethylene diisocyanate (“HDI”) homopolymer having an average NCO functionality of 2.5, wherein the blend has an average NCO functionality in the range of 2.05 to 2.35. In particular, it has been found that HDI polyisocyanate sold under the trademark, Desmodur® N3400 (available from Bayer Material Science, LLC, Pittsburgh, Pa.) is effective.
b) 70 to 50 wt. % of 4,4′-dicyclohexylmethane diisocyanate (“H₁₂ MDI,” i.e., bis(4-isocyanatocyclohexyl)-methane) and 30 to 50 wt. % of HDI homopolymer having an average NCO functionality of 2.5, wherein the blend has an average NCO functionality in the range of 2.05 to 2.35. In particular, it has been found that HDI polyisocyanate sold under the trademark, Desmodur® N3400 (Bayer Material Science) is effective.
c) 40 to 10 wt. % of H₁₂MDI and 60 to 90 wt. % of HDI homopolymer having an average NCO functionality of approximately 2.3, wherein the blend has an average NCO functionality in the range of 2.05 to 2.35. In particular, it has been found that HDI polyisocyanate sold under the trademark, Desmodur® XP 2730 (Bayer Material Science) is effective.
d) 90 to 80 wt. % of 4,4′-diphenylmethane diisocyanate (4,4′-MDI) and 10 to 20 wt. % of toluene diisocyanate (“TDI”) trimer, wherein the blend has an average NCO functionality in the range of 2.05 to 2.35.
e) 90 to 80 wt. % of 4,4′-MDI and 10 to 20 wt. % of HDI trimer, wherein the blend has an average NCO functionality in the range of 2.05 to 2.35.

The above-described aliphatic isocyanate blends (above examples a-c) can be reacted with polyols to produce polyurethanes and polyamines to produce polyureas having relatively high cut/tear-resistance, mechanical integrity, light stability, and thermal stability. The aliphatic isocyanate blends are able to provide polymers having advantageous mechanical properties normally found in polymers produced using aromatic isocyanate compounds. At the same time, the polymers have good light-stability and thermal-stability. As described above, it is important the isocyanate blends have an average NCO functionality in the range of 2.05 to 2.35. Regarding the above-described aromatic isocyanate blends (above examples d-e), these blends are able to react and form polymers having good mechanical properties such as high tensile strength and cut/tear-resistance as well as high thermal-stability. Moreover, the polymers produced using the isocyanate blends of this invention having high thermal-stability, even when the average NCO functionality is relatively low. For example, it has been found that isocyanate blends having an average NCO functionality of less than 2.20 can be used to produce polymers having high thermal-stability. In the following Table I, different sample isocyanate blends are described along with the physical properties of the resulting polymers. As shown in Table I, when isocyanate blends having an average NCO functionality outside of the range of 2.05 to 2.35 are used, the resulting polymers tend to have either poor thermal-stability or poor mechanical properties.

TABLE I
(Isocyanate Blends)

| | Average | | |
|---|---|---|---|
| | Functionality | | |
| | of Isocyanate | | Mechanical |
| Polymer | Blend | Thermal Stability | Properties |
| 6.5% NCO prepolymer | 3.00 | Good—maintains | Cuts and |
| made from HDI | | integrity above | tears. |
| homopolymer and | | 100° C. | |
| amine-terminated | | | |
| PTMEG cured with | | | |
| DETDA. | | | |
| 6.5% NCO prepolymer | 2.50 | Good—maintains | Cuts and |
| made from HDI | | integrity above | tears. |
| homopolymer and | | 100° C. | |
| amine-terminated | | | |
| PTMEG cured with | | | |
| DETDA. | | | |
| 7.0% NCO prepolymer | 2.00 | Melts and | Good impact |
| made from H₁₂MDI | | softens. | and shear |
| homopolymer and | | | durability. |
| amine-terminated | | | |
| PTMEG cured with | | | |
| DETDA. | | | |
| 7.2% NCO Prepolymer | 2.14 | Good—maintains | Good impact |
| made from 54% IPDI & | | integrity above | and shear |
| 46% HDI | | 100° C. | durability. |
| Homopolymer (fn = 2.5) | | | |
| and amine-terminated | | | |
| PTMEG cured with | | | |
| DETDA. | | | |
| 7.0% NCO Prepolymer | 2.13 | Good—maintains | Good impact |
| made with 60% H₁₂MDI | | integrity above | and shear |
| & 40% HDI | | 100° C. | durability. |
| Homopolymer (fn = 2.5) | | | |
| and amine-terminated | | | |
| PTMEG cured with | | | |
| DETDA. | | | |
| 7.2% NCO Prepolymer | 2.22 | Good—maintains | Good impact |
| made from 80% HDI | | integrity above | and shear |
| Homopolymer (¦n = 2.3) | | 100° C. | durability. |
| & 20% H₁₂MDI and | | | |
| amine-terminated | | | |
| PTMEG cured with | | | |
| DETDA. | | | |
| 6.5% NCO Prepolymer | 2.08 | Good—maintains | Good impact |
| made from 85% 4,4′- | | integrity above | and shear |
| MDI & 15% TDI | | 100° C. | durability. |
| Trimer and amine- | | | |
| terminated PTMEG | | | |
| cured with Ethacure | | | |
| 300. | | | |
| 6.5% NCO Prepolymer | 2.11 | Good—maintains | Good impact |
| made from 80% 4,4′- | | integrity above | and shear |
| MDI & 20% HDI | | 100° C. | durability. |
| Trimer and amine- | | | |
| terminated PTMEG | | | |
| cured with Ethacure | | | |
| 300. | | | |

Polyol Compounds

When forming a polyurethane prepolymer per this invention, any suitable polyol may be reacted with the above-described isocyanate blends in accordance with this invention. Exemplary polyols include, but are not limited to, polyether polyols, hydroxy-terminated polybutadiene (including partially/fully hydrogenated derivatives), polyester polyols, polycaprolactone polyols, and polycarbonate polyols. In one preferred embodiment, the polyol includes polyether polyol. Examples include, but are not limited to, polytetramethylene ether glycol (PTMEG), polyethylene propylene glycol, polyoxypropylene glycol, and mixtures thereof. The hydrocarbon chain can have saturated or unsaturated bonds and substituted or unsubstituted aromatic and cyclic groups. Preferably, the polyol of the present invention includes PTMEG.

In another embodiment, polyester polyols are included in the polyurethane material. Suitable polyester polyols include, but are not limited to, polyethylene adipate glycol; polybutylene adipate glycol; polyethylene propylene adipate glycol; o-phthalate-1,6-hexanediol; poly(hexamethylene adipate) glycol; and mixtures thereof. The hydrocarbon chain can have saturated or unsaturated bonds, or substituted or unsubstituted aromatic and cyclic groups. In still another embodiment, polycaprolactone polyols are included in the materials of the invention. Suitable polycaprolactone polyols include, but are not limited to: 1,6-hexanediol-initiated polycaprolactone, diethylene glycol initiated polycaprolactone, trimethylol propane initiated polycaprolactone, neopentyl glycol initiated polycaprolactone, 1,4-butanediol-initiated polycaprolactone, and mixtures thereof. The hydrocarbon chain can have saturated or unsaturated bonds, or substituted or unsubstituted aromatic and cyclic groups. In yet another embodiment, polycarbonate polyols are included in the polyurethane material of the invention. Suitable polycarbonates include, but are not limited to, polyphthalate carbonate and poly(hexamethylene carbonate) glycol. The hydrocarbon chain can have saturated or unsaturated bonds, or substituted or unsubstituted aromatic and cyclic groups. In one embodiment, the molecular weight of the polyol is from about 200 to about 4000.

Polyamine Compounds

When forming a polyurea prepolymer per this invention, any suitable polyamine may be reacted with the above-described isocyanate blends in accordance with this invention. Such polyamines include amine-terminated compounds, for example, amine-terminated hydrocarbons, polyethers, polyesters, polycarbonates, polycaprolactones, and mixtures thereof. The molecular weight of the amine compound is generally in the range of about 100 to about 10,000. Suitable polyether amines include, but are not limited to, methyldiethanolamine; polyoxyalkylenediamines such as, polytetramethylene ether diamines, polyoxypropylenetriamine, polyoxyethylene diamines, and polyoxypropylene diamines; poly(ethylene oxide capped oxypropylene) ether diamines; propylene oxide-based triamines; triethyleneglycoldiamines; glycerin-based triamines; and mixtures thereof. In one embodiment, the polyether amine used to form the prepolymer is Jeffamine D2000 (Huntsman Corp.). Additional amine-terminated compounds also may be useful in forming the polyurea prepolymers of the present invention including, but not limited to, poly(acrylonitrile-co-butadiene); poly(1,4-butanediol) bis(4-aminobenzoate) in liquid or waxy solid form; linear and branched polyethylene imine; low and high molecular weight polyethylene imine having an average molecular weight of about 500 to about 30,000; poly(propylene glycol) bis(2-aminopropyl ether) having an average molecular weight of about 200 to about 5,000; polytetrahydrofuran bis(3-aminopropyl) terminated having an average molecular weight of about 200 to about 2000; and mixtures thereof (Aldrich Co.). Preferably, the amine-terminated compound is a copolymer of polytetramethylene oxide and polypropylene oxide (Huntsman Corp.)

As discussed above, in general, the isocyanate blend may be reacted with polyol compounds to produce a polyurethane prepolymer. And, the isocyanate blend may be reacted with polyamine compounds to produce a polyurea prepolymer. As a result of the reaction between the isocyanate blend and polyamine and/or polyol compounds, there will be some unreacted NCO groups in the prepolymer. The prepolymer should have less than 14% unreacted NCO groups. Preferably, the prepolymer has no greater than 8.5% unreacted NCO groups, more preferably from 2.5% to 8%, and most preferably from 5.0% to 8.0% unreacted NCO groups. As the weight percent of unreacted isocyanate groups increases, the hardness of the composition also generally increases. The prepolymer method provides a relatively homogeneous mixture resulting in a more consistent polymer composition.

Curative Blends and Chain-Extending of Prepolymer

The polyurethane and polyurea prepolymers may be chain-extended by reacting the prepolymer with a curative blend in accordance with the present invention. The curative blend comprises a single curing agent or blend of curing agents (chain-extenders) and other components as discussed further below. In general, the prepolymer may be reacted with amine-terminated curing agents, hydroxyl-terminated curing agents, and mixtures thereof. The curing agents extend the chain length of the prepolymer and build-up its molecular weight. Normally, the prepolymer and curing agent are mixed so the isocyanate groups and hydroxyl and/or amine groups are mixed at a 1.05:1.00 stoichiometric ratio. In other embodiments, the isocyanate groups and hydroxyl and/or amine groups are mixed at a 1.00:1.00 stoichiometric ratio.

The hydroxyl chain-extending (curing) agents are preferably selected from the group consisting of ethylene glycol; diethylene glycol; polyethylene glycol; propylene glycol; 2-methyl-1,3-propanediol; 2-methyl-1,4-butanediol; monoethanolamine; diethanolamine; triethanolamine; monoisopropanolamine; diisopropanolamine; dipropylene glycol; polypropylene glycol; 1,2-butanediol; 1,3-butanediol; 1,4-butanediol; 2,3-butanediol; 2,3-dimethyl-2,3-butanediol; trimethylolpropane; cyclohexyldimethylol; triisopropanolamine; N,N,N′,N′-tetra-(2-hydroxypropyl)-ethylene diamine; diethylene glycol bis-(aminopropyl)ether; 1,5-pentanediol; 1,6-hexanediol; 1,3-bis-(2-hydroxyethoxy)cyclohexane; 1,4-cyclohexyldimethylol; 1,3-bis-[2-(2-hydroxyethoxy)ethoxy]cyclohexane; 1,3-bis-{2-[2-(2-hydroxyethoxy)ethoxy]ethoxy}cyclohexane; trimethylolpropane; polytetramethylene ether glycol (PTMEG), preferably having a molecular weight from about 250 to about 3900; and mixtures thereof.

Suitable amine chain-extending (curing) agents that can be used in chain-extending the polyurea prepolymer of this invention include, but are not limited to, unsaturated diamines such as 4,4′-diamino-diphenylmethane (i.e., 4,4′-methylene-dianiline or “MDA”), m-phenylenediamine, p-phenylenediamine, 1,2- or 1,4-bis(sec-butylamino)benzene, 3,5-diethyl-(2,4- or 2,6-) toluenediamine or “DETDA”, 3,5-dimethylthio-(2,4- or 2,6-)toluenediamine, 3,5-diethylthio-(2,4- or 2,6-)toluenediamine, 3,3′-dimethyl-4,4′-diamino-diphenylmethane, 3,3′-diethyl-5,5′-dimethyl-4,4′-diamino-diphenylmethane (i.e., 4,4′-methylene-bis(2-ethyl-6-methyl-benezeneamine)), 3,3′-dichloro-4,4′-diamino-diphenylmethane (i.e., 4,4′-methylene-bis(2-chloroaniline) or “MOCA”), 3,3′,5,5′-tetraethyl-4,4′-diamino-diphenylmethane (i.e., 4,4′-methylene-bis(2,6-diethylaniline), 2,2′-dichloro-3,3′,5,5′-tetraethyl-4,4′-diamino-diphenylmethane (i.e., 4,4′-methylene-bis(3-chloro-2,6-diethyleneaniline) or “MCDEA”), 3,3′-diethyl-5,5′-dichloro-4,4′-diamino-diphenylmethane, or “MDEA”), 3,3′-dichloro-2,2′,6,6′-tetraethyl-4,4′-diamino-diphenylmethane, 3,3′-dichloro-4,4′-diamino-diphenylmethane, 4,4′-methylene-bis(2,3-dichloroaniline) (i.e., 2,2′,3,3′-tetrachloro-4,4′-diamino-diphenylmethane or “MDCA”), 4,4′-bis(sec-butylamino)-diphenylmethane, N,N′-dialkylamino-diphenylmethane, trimethyleneglycol-di(p-aminobenzoate), polyethyleneglycol-di(p-aminobenzoate), polytetramethyleneglycol-di(p-aminobenzoate); saturated diamines such as ethylene diamine, 1,3-propylene diamine, 2-methyl-pentamethylene diamine, hexamethylene diamine, 2,2,4- and 2,4,4-trimethyl-1,6-hexane diamine, imino-bis(propylamine), imido-bis(propylamine), methylimino-bis(propylamine) (i.e., N-(3-aminopropyl)-N-methyl-1,3-propanediamine), 1,4-bis(3-aminopropoxy)butane (i.e., 3,3′-[1,4-butanediylbis-(oxy)bis]-1-propanamine), diethyleneglycol-bis(propylamine) (i.e., diethyleneglycol-di(aminopropyl)ether), 4,7,10-trioxamidecane-1,13-diamine, 1-methyl-2,6-diamino-cyclohexane, 1,4-diamino-cyclohexane, poly(oxyethylene-oxypropylene)diamines, 1,3- or 1,4-bis(methylamino)-cyclohexane, isophorone diamine, 1,2- or 1,4-bis(sec-butylamino)-cyclohexane, N,N′-diisopropyl-isophorone diamine, 4,4′-diamino-dicyclohexylmethane, 3,3′-dimethyl-4,4′-diamino-dicyclohexylmethane, 3,3′-dichloro-4,4′-diamino-dicyclohexylmethane, N,N′-dialkylamino-dicyclohexylmethane, polyoxyethylene diamines, 3,3′-diethyl-5,5′-dimethyl-4,4′-diamino-dicyclohexylmethane, polyoxypropylene diamines, 3,3′-diethyl-5,5′-dichloro-4,4′-diamino-dicyclohexylmethane, polytetramethylene ether diamines, 3,3′,5,5′-tetraethyl-4,4′-diamino-dicyclohexylmethane (i.e., 4,4′-methylene-bis(2,6-diethylaminocyclohexane)), 3,3′-dichloro-4,4′-diamino-dicyclohexylmethane, 2,2′-dichloro-3,3′,5,5′-tetraethyl-4,4′-diamino-dicyclohexylmethane, (ethylene oxide)-capped polyoxypropylene ether diamines, 2,2′,3,3′-tetrachloro-4,4′-diamino-dicyclohexylmethane, 4,4′-bis(sec-butylamino)-dicyclohexylmethane; triamines such as diethylene triamine, dipropylene triamine, (propylene oxide)-based triamines (i.e., polyoxypropylene triamines), N-(2-aminoethyl)-1,3-propylenediamine (i.e., N₃-amine), glycerin-based triamines, (all saturated); tetramines such as N,N′-bis(3-aminopropyl)ethylene diamine (i.e., N₄-amine) (both saturated), triethylene tetramine; and other polyamines such as tetraethylene pentamine (also saturated). One suitable amine-terminated chain-extending agent is Ethacure 300™ (dimethylthiotoluenediamine or a mixture of 2,6-diamino-3,5-dimethylthiotoluene and 2,4-diamino-3,5-dimethylthiotoluene.) The amine curing agents used as chain extenders normally have a cyclic structure and a low molecular weight (250 or less).

As discussed above, in general, the chain length of the polyurethane prepolymer is extended by reacting it with short-chain diols (OH—R′—OH). The resulting polyurethane polymer contains urethane linkages. Amine-terminated curing agents also may be used in the chain-extending step. When the polyurethane prepolymer is reacted with amine-terminated curing agents, any excess isocyanate groups in the prepolymer will react with the amine groups and create urea linkages. The resulting polyurethane polymer contains urethane and urea linkages and may be referred to as a “hybrid of polyurethane and polyurea.” By the term, “hybrid of polyurethane and polyurea” it also is meant to include copolymers and blends of polyurethanes and polyureas.

Also, as discussed above, in general, the chain length of the polyurea prepolymer is extended by reacting it with polyamines containing amine groups (NH or NH₂). The resulting polyurea polymer contains urea linkages. Hydroxyl-terminated curing agents also may be used in the chain-extending step. When the polyurea prepolymer is reacted with hydroxyl-terminated curing agents, any excess isocyanate groups in the prepolymer will react with the hydroxyl groups and create urethane linkages. The resulting polyurea composition also contains urethane and urea linkages and may be referred to as a hybrid of polyurethane and polyurea.

The curative blend further comprises a freezing point depressing agent so that the freezing point of the blend is less than its normal freezing point temperature. Suitable freezing point depressing agents that may be used in accordance with this invention are described in S. Wu et al, U.S. Pat. No. 7,888,449, the disclosure of which is hereby incorporated by reference. Adding the freezing point depressing agent to the blend produces a modified curative blend having storage-stable pigment dispersion. As used herein, the term “storage-stable” refers to the ability of a blend, composition, or the like, to resist freezing at room temperature (about 68° F. to about 77° F.) and below (down to about −15° F.).

Since the modified curative blend resists freezing, the pigments contained in the blend tend to remain in dispersed form and do not form agglomerates or aggregates. This helps produce a more homogeneous polyurethane or polyurea composition. More particularly, the freezing point depressing agent (solute) is added to the curative blend (solvent) and causes the mixture to remain as a liquid at temperatures below temperatures where the blend would normally freeze and solidify. Thus, the freezing point of the modified blend (solution) is lower than the freezing point of the pure blend (pure solvent that does not contain any freezing point depressing agent).

Conventional techniques may be used to determine the freezing point of a blend, using the standard freezing point determination. For example, an empirical method of freezing point determination is to cool the sample, which may be done by surrounding it with an ice bath while stirring, and record the temperature at regular intervals, for example, every minute, until the material begins to solidify. As solidification occurs, the temperature begins to level off, which signifies the freezing point of the material. In addition, analytical methods of determining the freezing point may also be used such as Differential Scanning calorimetry (DSC).

The freezing point depressing agent is soluble with the curing agent. For example, a hydroxy-terminated curing agent such as 1,4-butanediol having a relatively high freezing point may be modified with hydroxy-terminated freezing point depressing agents. Examples of hydroxy-terminated freezing point depressing agents include, but are not limited to, 1,3-propanediol, 2-methyl-1,3-propanediol, 2-methyl-1,4-butanediol, 1,2-butanediol, 1,3-butanediol, ethylene glycol, diethylene glycol, 1,5-pentanediol, polytetramethylene glycol, propylene glycol, dipropylene glycol, and mixtures thereof. Thus, the freezing point of these hydroxy curing agents is lowered to a temperature below their normal freezing point by adding these depressing agents to the blend.

In addition, a number of amine-terminated curing agents have relatively high freezing points, for example, hexamethylene diamine (105.8° F.), diethanolamine (82.4° F.), triethanol amine (69.8° F.), diisopropanolamine (73.4° F.), and triisopropanolamine (111.2° F.) may be modified with amine-terminated freezing point depressing agents. That is, the freezing point of these amine curing agents is lowered to a temperature below their normal freezing point by adding these depressing agents to the blend. Suitable amine-terminated freezing point depressing agents include, but are not limited to, ethylene diamine, 1,3-diaminopropane, dimethylamino propylamine, tetraethylene pentamine, 1,2-propylenediamine, diethylaminopropylamine, 2,2,4-trimethyl-1,6-hexanediamine, 2,4,4-trimethyl-1,6-hexanediamine, and mixtures thereof.

The freezing point depressing agent is preferably added in an amount sufficient to reduce the freezing point of the curing agent by a suitable amount to prevent loss of pigment dispersion, but not affect the physical properties of the golf ball. In one embodiment, the freezing point depressing agent is added to the curing agent in an amount of about 5 percent or greater by weight of the curative blend, i.e., curing agent(s), freezing point depressing agent. In another embodiment, the freezing point depressing agent is present in an amount of about 10 percent or greater. The curative blend may also include a freezing point depressing agent in an amount of about 14 percent or greater by weight of the curative blend.

Because the modified curative blend results in a storage-stable pigment dispersion, any compatible pigment may be dispersed in the blend. Even some pigments, that are generally difficult to maintain in dispersion, may be used. For example, titanium dioxide is known to be difficult to maintain in dispersion because of the high concentrations typically used to obtain opacity, but this pigment may be used in the curative blends of this invention. Examples of suitable pigments include, but are not limited to, titanium dioxide; inorganic pigments such as red or yellow iron oxides, carbon black, and ultramarine blue, organic pigments such as phthalocyanine blue, phthalocyanine green, carbazole violets, and naphthol reds; and mixtures thereof.

In addition, the pigment may be incorporated into a premade colorant or tint, such as those commercially available from Polyone Corporation of Avon Lake, Ohio. These premade colorants or tints generally contain pigments dispersed in a grind vehicle, for example, high molecular weight polyols.

The curative blend may contain other additives in addition to the pigments discussed above. For example, a catalyst may be employed to promote the reaction between the isocyanate and polyol compounds for producing the polyurethane prepolymer or between the polyurethane prepolymer and curing agent during the chain-extending step. Preferably, the catalyst is added to the reactants before producing the polyurethane prepolymer. However, the catalysts also may be added to the curative blend. Suitable catalysts include, but are not limited to, bismuth catalyst; zinc octoate; stannous octoate; tin catalysts such as bis-butyltin dilaurate, bis-butyltin diacetate, stannous octoate; tin (II) chloride, tin (IV) chloride, bis-butyltin dimethoxide, dimethyl-bis[1-oxonedecyl)oxy]stannane, di-n-octyltin bis-isooctyl mercaptoacetate; amine catalysts such as triethylenediamine, triethylamine, and tributylamine; organic acids such as oleic acid and acetic acid; delayed catalysts; and mixtures thereof. The same catalysts may be used in connection with producing the polyurea prepolymer or to facilitate the reaction between the polyurea prepolymer and curing agent. The catalyst is preferably added in an amount sufficient to catalyze the reaction of the components in the reactive mixture. In one embodiment, the catalyst is present in an amount from about 0.001 percent to about 1 percent, and preferably 0.1 to 0.5 percent, by weight of the composition.

Ball Construction

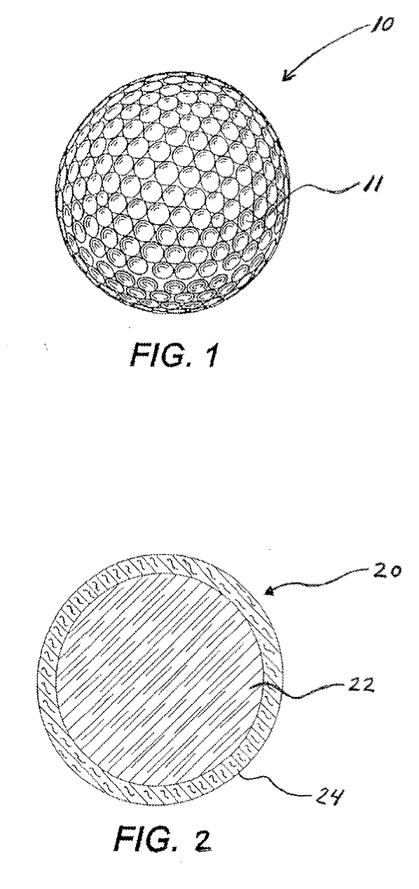

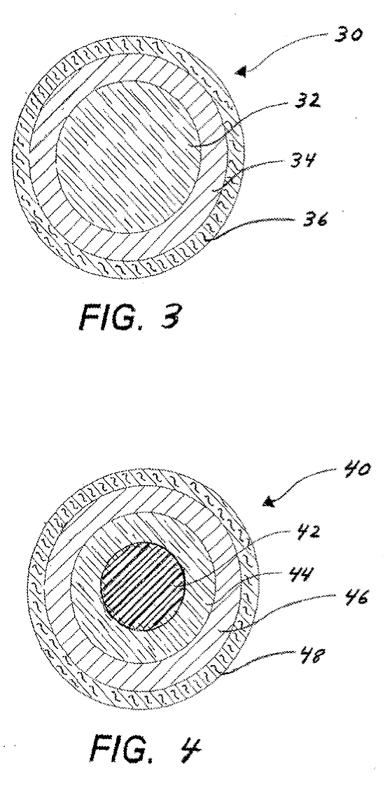

The polyurethane and polyurea cover materials of this invention may be used with any type of ball construction known in the art. Such golf ball designs include, for example, two-piece, three-piece, and four-piece designs. The core, intermediate casing, and cover can be single or multi-layered. Referring to FIG. 1, one version of a golf ball that can be made in accordance with this invention is generally indicated at (10). Various patterns and geometric shapes of dimples (11) can be used to modify the aerodynamic properties of the golf ball (10). Referring to FIG. 2, a two-piece golf ball (20) that can be made in accordance with this invention is illustrated. In this version, the ball (20) includes a solid core (22) and cover (24). In FIG. 3, a three-piece golf ball (30) having a solid core (32), an intermediate layer (34), and cover (36) is shown.

Core

The core of the golf ball may be solid, semi-solid, fluid-filled, or hollow, and the core may have a single-piece or multi-piece structure. The cores in the golf balls of this invention are typically made from rubber compositions containing a base rubber, free-radical initiator agent, cross-linking co-agent, and fillers. The base rubber may be selected, for example, from polybutadiene rubber, polyisoprene rubber, natural rubber, ethylene-propylene rubber, ethylene-propylene diene rubber, styrene-butadiene rubber, and combinations of two or more thereof. A preferred base rubber is polybutadiene. Another preferred base rubber is polybutadiene optionally mixed with one or more elastomers such as polyisoprene rubber, natural rubber, ethylene propylene rubber, ethylene propylene diene rubber, styrene-butadiene rubber, polystyrene elastomers, polyethylene elastomers, polyurethane elastomers, polyurea elastomers, acrylate rubbers, polyoctenamers, metallocene-catalyzed elastomers, and plastomers. The base rubber typically is mixed with at least one reactive cross-linking co-agent to enhance the hardness of the rubber composition. Suitable co-agents include, but are not limited to, unsaturated carboxylic acids and unsaturated vinyl compounds. A preferred unsaturated vinyl is trimethylolpropane methacrylate.

The rubber composition is cured using a conventional curing process. Suitable curing processes include, for example, peroxide curing, sulfur curing, high-energy radiation, and combinations thereof. In one embodiment, the base rubber is peroxide cured. Organic peroxides suitable as free-radical initiators include, for example, dicumyl peroxide; n-butyl-4,4-di(t-butylperoxy)valerate; 1,1-di(t-butylperoxy)3,3,5-trimethylcyclohexane; 2,5-dimethyl-2,5-di(t-butylperoxy)hexane; di-t-butyl peroxide; di-t-amyl peroxide; t-butyl peroxide; t-butyl cumyl peroxide; 2,5-dimethyl-2,5-di(t-butylperoxy)hexyne-3; di(2-t-butyl-peroxyisopropyl)benzene; dilauroyl peroxide; dibenzoyl peroxide; t-butyl hydroperoxide; and combinations thereof. Cross-linking agents are used to cross-link at least a portion of the polymer chains in the composition. Suitable cross-linking agents include, for example, metal salts of unsaturated carboxylic acids having from 3 to 8 carbon atoms; unsaturated vinyl compounds and polyfunctional monomers (e.g., trimethylolpropane trimethacrylate); phenylene bismaleimide; and combinations thereof. In a particular embodiment, the cross-linking agent is selected from zinc salts of acrylates, diacrylates, methacrylates, and dimethacrylates. In another particular embodiment, the cross-linking agent is zinc diacrylate (“ZDA”). Commercially available zinc diacrylates include those selected from Rockland React-Rite and Sartomer.

The rubber compositions also may contain “soft and fast” agents such as a halogenated organosulfur, organic disulfide, or inorganic disulfide compounds. Particularly suitable halogenated organosulfur compounds include, but are not limited to, halogenated thiophenols. Preferred organic sulfur compounds include, but not limited to, pentachlorothiophenol (“PCTP”) and a salt of PCTP. A preferred salt of PCTP is ZnPCTP. A suitable PCTP is sold by the Struktol Company (Stow, Ohio) under the tradename, A95. ZnPCTP is commercially available from EchinaChem (San Francisco, Calif.). These compounds also may function as cis-to-trans catalysts to convert some cis-1, 4 bonds in the polybutadiene to trans-1, 4 bonds. Antioxidants also may be added to the rubber compositions to prevent the breakdown of the elastomers. Other ingredients such as accelerators (for example, tetra methylthiuram), processing aids, dyes and pigments, wetting agents, surfactants, plasticizers, as well as other additives known in the art may be added to the rubber composition. The core may be formed by mixing and forming the rubber composition using conventional techniques. These cores can be used to make finished golf balls by surrounding the core with outer core layer(s), intermediate layer(s), and/or cover layers as discussed further below. In another embodiment, the cores can be formed using highly neutralized polymer (HNP) compositions as disclosed in U.S. Pat. Nos. 6,756,436, 7,030,192, 7,402,629, and 7,517,289. Furthermore, the cores from the highly neutralized polymer compositions can be further cross-linked using any cross-linkable sources including radiation sources such as gamma or electron beam as well as chemical sources such as peroxides and the like.

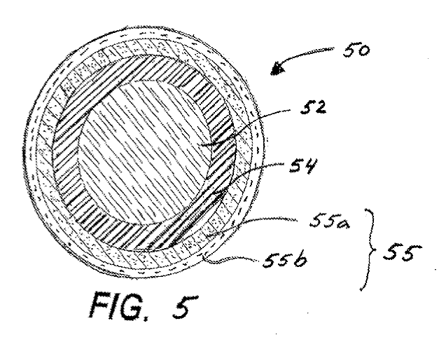

Golf balls made in accordance with this invention can be of any size, although the USGA requires that golf balls used in competition have a diameter of at least 1.68 inches and a weight of no greater than 1.62 ounces. For play outside of USGA competition, the golf balls can have smaller diameters and be heavier. For example, the diameter of the golf ball may be in the range of about 1.68 to about 1.80 inches. In one embodiment, as shown in FIG. 2, the core is a single-piece having an outside diameter of about 1.00 to about 1.65 inches. Preferably, the single-piece core has a diameter of about 1.50 to about 1.64 inches. The core generally makes up a substantial portion of the ball, for example, the core may constitute at least about 90% of the ball. The hardness of the core may vary depending upon desired properties of the ball. In general, core hardness is in the range of about 10 to about 75 Shore D and more preferably in the range of about 10 to about 60 Shore D. The compression of the core is generally in the range of about 30 to about 110 and more preferably in the range of about 50 to about 100. In general, when the ball contains a relatively soft core, the resulting a driver spin rate of the ball is relatively low. On the other hand, when the ball contains a relatively hard core, the resulting spin rate of the ball is relatively high. In another embodiment, as shown in FIG. 4, the golf ball (40) contains a core made of two pieces. The inner core (42) is made of a first rubber composition as described above, while the outer core layer (44) is made of a second rubber composition. The first and second rubber compositions contain different ingredients. The golf ball further includes an intermediate casing layer (46) and polyurethane or polyurea cover layer (48). Conventional thermoplastic or thermoset resins such as ethylene-based ionomeric copolymers, polyamides, polyesters, polycarbonates, polyolefins, polyurethanes, and polyureas as described above can be used to make the intermediate (casing) layer (46).

In such multi-layered cores, the inner core (42) preferably has a diameter of about 0.50 to about 1.30 inches, more preferably 1.00 to 1.15 inches, and is relatively soft (that is, it may have a compression of less than about 30.) Meanwhile, the encapsulating outer core layer (44) generally has a thickness of about 0.030 to about 0.070 inches, preferably 0.035 to 0.065 inches and is relatively hard (compression of about 70 or greater.) The outer core layer (44) preferably has a Shore D surface hardness in the range of about 40 to about 70. That is, the two-piece core, which is made up of the inner core (42) and outer core layer (44), preferably has a total diameter of about 1.50 to about 1.64 inches, more preferably 1.510 to 1.620 inches, and a compression of about 80 to about 115, more preferably 85 to 110.

Intermediate Layer

The golf balls of this invention preferably include at least one intermediate layer. As used herein, the term, “intermediate layer” means a layer of the ball disposed between the core and cover. The intermediate layer may be considered an outer core layer or inner cover layer or any other layer disposed between the inner core and outer cover of the ball. The intermediate layer also may be referred to as a casing or mantle layer. The intermediate layer preferably has water vapor barrier properties to prevent moisture from penetrating into the rubber core. The ball may include one or more intermediate layers disposed between the inner core and outer cover. Referring to FIGS. 3-5, the golf balls are shown containing at least one intermediate casing layer positioned between the core and cover layers. The intermediate layer may be made of any suitable material known in the art including thermoplastic and thermosetting materials.

Suitable thermoplastic compositions for forming the intermediate core layer include, but are not limited to, partially- and fully-neutralized ionomers, particularly olefin-based ionomer copolymers such as ethylene and a vinyl comonomer having an acid group such as methacrylic, acrylic acid, or maleic acid; graft copolymers of ionomer and polyamide, and the following non-ionomeric polymers: polyesters; polyamides; polyamide-ethers, and polyamide-esters; polyurethanes, polyureas, and polyurethane-polyurea hybrids; fluoropolymers; non-ionomeric acid polymers, such as E/Y- and E/X/Y-type copolymers, wherein E is an olefin (e.g., ethylene), Y is a carboxylic acid, and X is a softening comonomer such as vinyl esters of aliphatic carboxylic acids, and alkyl alkylacrylates; metallocene-catalyzed polymers; polystyrenes; polypropylenes and polyethylenes; polyvinyl chlorides and grafted polyvinyl chlorides; polyvinyl acetates; polycarbonates including polycarbonate/acrylonitrile-butadiene-styrene blends, polycarbonate/polyurethane blends, and polycarbonate/polyester blends; polyvinyl alcohols; polyethers; polyimides, polyetherketones, polyamideimides; and mixtures of any two or more of the above thermoplastic polymers. The olefin-based ionomer resins are copolymers of olefin (for example, ethylene) and α,β-ethylenically unsaturated carboxylic acid (for example, acrylic acid or methacrylic acid) that normally have 10% to 100% of the carboxylic acid groups neutralized by metal cations.

Examples of commercially available thermoplastics suitable for forming the intermediate core layer include, but are not limited to, Pebax® thermoplastic polyether block amides, commercially available from Arkema Inc.; Surlyn® ionomer resins, Hytrel® thermoplastic polyester elastomers, and ionomeric materials sold under the trade names DuPont® HPF 1000 and HPF 2000, all of which are commercially available from E. I. du Pont de Nemours and Company; Iotek® ionomers, commercially available from ExxonMobil Chemical Company; Amplify® IO ionomers of ethylene acrylic acid copolymers, commercially available from The Dow Chemical Company; Clarix® ionomer resins, commercially available from A. Schulman Inc.; Elastollan® polyurethane-based thermoplastic elastomers, commercially available from BASF; and Xylex® polycarbonate/polyester blends, commercially available from SABIC Innovative Plastics. The above-mentioned filler materials may be added to the intermediate layer composition to modify such properties as the specific gravity, density, hardness, weight, modulus, resiliency, compression, and the like.

The ionomeric resins may be blended with non-ionic thermoplastic resins. Examples of suitable non-ionic thermoplastic resins include, but are not limited to, polyurethane, poly-ether-ester, poly-amide-ether, polyether-urea, thermoplastic polyether block amides (e.g., Pebax® block copolymers, commercially available from Arkema Inc.), styrene-butadiene-styrene block copolymers, styrene(ethylene-butylene)-styrene block copolymers, polyamides, polyesters, polyolefins (e.g., polyethylene, polypropylene, ethylene-propylene copolymers, polyethylene-(meth)acrylate, polyethylene-(meth)acrylic acid, functionalized polymers with maleic anhydride grafting, Fusabond® functionalized polymers commercially available from E. I. du Pont de Nemours and Company, functionalized polymers with epoxidation, elastomers (e.g., ethylene propylene diene monomer rubber, metallocene-catalyzed polyolefin) and ground powders of thermoset elastomers.

Cover Layer

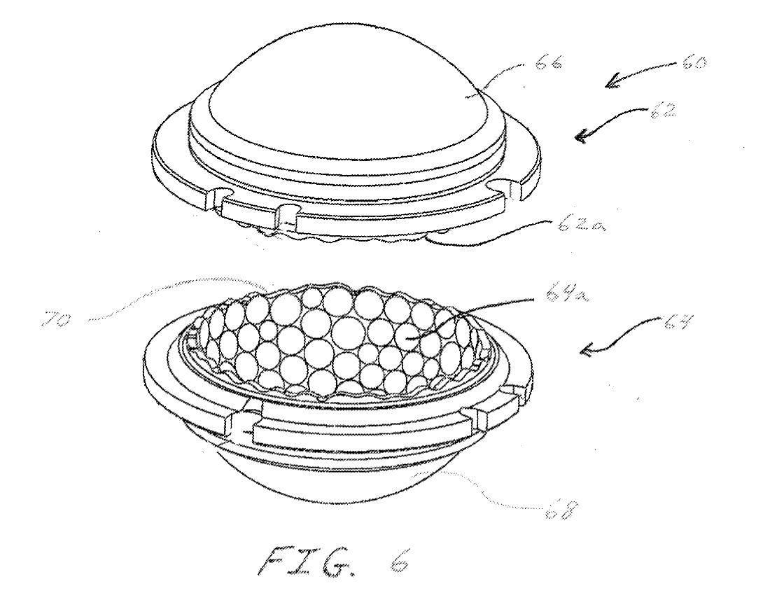

Turning to FIG. 5, a four-piece golf ball (50) having a multi-layered cover is shown. The ball (50) includes a solid, one-piece rubber core (52), an intermediate layer (54), and multi-layered cover (55) constituting an inner cover layer (55a) and outer cover layer (55b). In this version, the inner cover layer (55a) is made of a conventional thermoplastic or thermosetting resin. For example, the inner cover (55a) may be made of polyurethane, polyurea, ionomer resin or any of the other cover materials described above. The inner cover (55a) preferably has a thickness of about 0.020 to about 0.050 inches and Shore D material hardness of about 50 to about 70. The outer cover layer (55a), which surrounds the inner cover layer (55b), is made of the polyurethane or polyurea composition of this invention. The outer cover layer (55b) preferably has a thickness in the range of about 0.010 to about 0.035 inches and a Shore D material hardness in the range of about 45 to about 65. In another embodiment, a five-piece ball (not shown) may be made. The ball may include a core, intermediate layer (or outer core), and multi-layered cover constituting inner cover, intermediate cover, and outer cover layers.

It should be understood that the golf ball constructions shown in FIGS. 1-5 are for illustrative purposes only and are not meant to be restrictive. A wide variety of golf ball constructions may be made in accordance with the present invention depending upon the desired properties of the ball so long as at least one layer contains the polyurethane or polyurea composition of this invention. The term, “layer” as used herein means generally any spherical portion of the golf ball. As discussed above, such constructions include, but are not limited to, three-piece, four-piece, and five-piece designs and the cores, intermediate layers, and/or covers may be single or multi-layered. Numerous other golf ball constructions having layers made of the polyurea and polyurea/urethane composition of this invention may be made.

More particularly, in one preferred version of the ball covering, the polymer matrix constituting the ball covering consists of 100% by weight of the polyurethane or polyurea composition of this invention. In another version, the polymer matrix of the ball covering comprises a polymeric blend. In one version, the polyurethanes or polyureas of this invention may be blended with non-ionomeric polymers to form the composition that will be used to make the golf ball cover. Examples of non-ionomeric polymers include vinyl resins, polyolefins including those produced using a single-site catalyst or a metallocene catalyst, polyamides, polyphenylenes, polycarbonates, polyesters, polyacrylates, engineering thermoplastics, and the like. In general, the blend may contain about 10 to about 90% by weight of the polyurethane or polyurea and about 90 to about 10% by weight of a non-ionomeric polymer.

In yet another version, the polyurethanes or polyureas are blended with olefin-based ionomers, such as ethylene-based ionic copolymers, which normally include an unsaturated carboxylic acid, such as methacrylic acid, acrylic acid, or maleic acid. Other possible carboxylic acid groups include, for example, crotonic, maleic, fumaric, and itaconic acid. Low acid and high acid olefin-based ionomers, as well as blends of such ionomers, may be used. The acidic group in the olefin-based ionic copolymer is partially or totally neutralized with metal ions such as zinc, sodium, lithium, magnesium, potassium, calcium, manganese, nickel, chromium, copper, or a combination thereof. For example, ionomeric resins having carboxylic acid groups that are neutralized from about 10 percent to about 100 percent may be used. In one embodiment, the neutralization level is from 10 to 80%, more preferably 20 to 70%, and most preferably 30 to 50%. In another embodiment, the neutralization level is from 80 to 100%, more preferably 90 to 100%, and most preferably 95 to 100%. The blend may contain about 10 to about 90% by weight of the polyurethane or polyurea and about 90 to about 10% by weight of a partially, highly, or fully-neutralized olefin-based ionomeric copolymer.

The polyurethane and polyurea compositions making up the covers of the golf balls may contain additives, ingredients, and other materials that do not detract from the properties of the final composition. These additional materials include, but are not limited to, catalysts, wetting agents, coloring agents, optical brighteners, cross-linking agents, whitening agents such as titanium dioxide and zinc oxide, UV light absorbers, hindered amine light stabilizers, defoaming agents, processing aids, surfactants, and other conventional additives. For example, wetting additives may be added to more effectively disperse the pigments. Other suitable additives include antioxidants, stabilizers, softening agents, plasticizers, including internal and external plasticizers, impact modifiers, foaming agents, density-adjusting fillers, reinforcing materials, compatibilizers, and the like. Density-adjusting fillers can be added to modify the modulus, tensile strength, and other properties of the compositions. Examples of useful fillers include zinc oxide, zinc sulfate, barium carbonate, barium sulfate, calcium oxide, calcium carbonate, clay, tungsten, tungsten carbide, silica, and mixtures thereof. Regrind (recycled core material) high-Mooney-viscosity rubber regrind, and polymeric, ceramic, metal, and glass microspheres also may be used. Generally, the additives will be present in the composition in an amount between about 1 and about 70 weight percent based on the total weight of the composition depending upon the desired properties.

Manufacturing Methods

The solid cores for the golf balls of this invention may be made using any suitable conventional technique such as, for example, compression or injection molding. Typically, the inner core is formed by compression molding a slug of uncured or lightly cured rubber material into a spherical structure. If there is an outer core layer surrounding the inner core, this layer may be is formed by molding a second rubber or other composition over the inner core. Compression or injection molding techniques may be used. Then, the intermediate and/or cover layers are applied. Prior to this step, the core structure may be surface-treated to increase the adhesion between its outer surface and the next layer that will be applied over the core. Such surface-treatment may include mechanically or chemically-abrading the outer surface of the core. For example, the core may be subjected to corona-discharge, plasma-treatment, silane-dipping, or other treatment methods known to those in the art.

The intermediate or inner cover layers may be formed over the core using any suitable conventional technique. For example, an ethylene acid copolymer ionomer composition, which will be used to form the inner cover, may be injection-molded to produce half-shells. Alternatively, the ionomer composition can be placed into a compression mold and molded under sufficient pressure, temperature, and time to produce the half-shells. The smooth-surfaced half-shells are then placed around the ball subassembly in a compression mold. Under sufficient heating and pressure, the shells fuse together to form an inner cover layer that surrounds the core structure. In another method, the ionomer composition is injection-molded directly onto the core using retractable pin injection molding.

The outer cover layer comprising the polyurethane or polyurea composition of this invention may be formed over the ball subassembly using the casting method of this invention.

This method involves preparing a castable composition comprising a reactive mixture of a polyurethane or polyurea prepolymer and curative blend. A motorized mixer can be used to mix the polyurethane or polyurea prepolymer together and form a reactive liquid mixture. An exothermic reaction occurs when the polyurethane prepolymer and curative blend are mixed together and this continues as the reactive mixture is dispensed into the mold cavities (otherwise known as half-molds or mold cups).

Referring to FIG. 6, one embodiment of a golf ball mold that may be used in accordance with this invention is shown. The mold (60) comprises hemispherical-shaped mold cavities (62) and (64) having interior dimple patterns (62a) and (64a). The mold cavities (62, 64) may be referred to as first and second or upper and lower mold cavities, respectively. Various geometrical dimple patterns may be used depending upon the desired aerodynamic properties for the ball. in accordance with this invention as discussed further below. The mold cavities (62, 64) include hemispherical bases (66, 68) that are constructed so they fit into mold frames (not shown). The mold frames have recessed areas for holding multiple mold cavities. For example, each mold frame may hold four mold cavities. Preferably, the mold cavities (62, 64) are made from a metal material, for example, brass or silicon bronze. When the mold cavities (62, 64) are joined together, they define an interior spherical cavity that forms the cover for the ball. The castable cover material in the mold cavities adheres to the golf ball subassembly (not shown) to form a unitary cover structure. The cover material encapsulates the inner ball. Furthermore, the cover material conforms to the interior geometry (62a, 64a) of the mold cavities to form a dimple pattern on the surface of the ball. The mold cavities are mated together along a parting line (70) that creates an equator or seam for the finished ball. It is understood that different parting lines and dimple patterns may be used in the ball structure. The mold cavities shown in FIG. 6 are for illustrative purposes only and not meant to be restrictive.

Typically, the preheated lower and upper mold cavities in the mold frames are each filled with substantially equal amounts of the reactive mixture. Ball suction cups are used to hold the ball subassembly in place via reduced pressure or partial vacuum. After sufficient gelling of the reactive mixture (typically about 4 to about 12 seconds) in the mold cavities, the vacuum is removed and the ball subassembly is released at a controlled speed into the mold cavity. Then, the upper mold cavity is mated with the lower mold cavity under sufficient pressure and heat. and this continues until the cover material encapsulates the ball subassembly and solidifies. Finally, the molded balls are cooled in the mold and removed when the molded cover is hard enough to be handled without deforming.

Prior to forming the cover layer, the ball subassembly may be surface-treated to increase the adhesion between its outer surface and cover material. Examples of such surface-treatment may include mechanically or chemically abrading the outer surface of the subassembly. Additionally, the subassembly may be subjected to corona discharge, plasma treatment, silane dipping, or other chemical treatment methods known to those of ordinary skill in the art prior to forming the cover around it. Other layers of the ball, for example, the core and cover layers, also may be surface-treated. Examples of these and other surface-treatment techniques can be found in U.S. Pat. No. 6,315,915, the disclosure of which is hereby incorporated by reference.

A dispensing process as described in U.S. Pat. Nos. 7,655,171; 7,490,975; and 7,246,937, the disclosures of which are hereby incorporated by reference, can be used in accordance with the present invention. This process involves pumping the reactive polyurethane or polyurea components into a mixer body and mixing them together with a dynamic mixer element. The components are heated to a temperature in the range of about 100° F. to about 350° F. as the components flow through a dispensing port, which dispenses the components into the lower and upper half-molds. The dispensing port moves into and out of the mold cavity by pneumatic pressure so the components are deposited uniformly into the half-molds.

In another embodiment, a conveyor belt system can be used for transporting the mold frames as described in co-assigned, co-pending, U.S. patent application Ser. No. 12/614,814, the disclosure of which is hereby incorporated by reference. In this system, the lower and upper mold frame plates containing the mold cavities are pre-heated to a temperature in the range of about 140° to about 190° F. Dispensing ports are used to inject the polyurethane or polyurea mixture into the mold cavities. The upper mold frame plates containing the upper mold cavities are fed to a golf ball sub-assembly supply station, where the ball sub-assemblies are introduced into the cavities. The lower mold frame plates containing the lower mold cavities continue moving forward on the main conveyor belt line. At the next station, the upper and lower mold frame plates are fastened together.

After the golf balls have been removed from the mold, they may be subjected to finishing steps such as flash-trimming, surface-treatment, marking, coating, and the like using techniques known in the art. For example, in traditional white-colored golf balls, the white-pigmented cover may be surface-treated using a suitable method such as, for example, corona, plasma, or ultraviolet (UV) light-treatment. Then, indicia such as trademarks, symbols, logos, letters, and the like may be printed on the ball's cover using pad-printing, ink-jet printing, dye-sublimation, or other suitable printing methods. Clear surface coatings (for example, primer and top-coats), which may contain a fluorescent whitening agent, are applied to the cover. The resulting golf ball has a glossy and durable surface finish.

In another finishing process, the golf balls are painted with one or more paint coatings. For example, white primer paint may be applied first to the surface of the ball and then a white top-coat of paint may be applied over the primer. Of course, the golf ball may be painted with other colors, for example, red, blue, orange, and yellow. As noted above, markings such as trademarks and logos may be applied to the painted cover of the golf ball. Finally, a clear surface coating may be applied to the cover to provide a shiny appearance and protect any logos and other markings printed on the ball.

As discussed above, the lower and upper mold cavities (62, 64) are mated together to form the outer cover layer for the ball. The outer cover material encapsulates the inner ball. The mold cavities used to form the outer layer have interior dimple cavity details. The cover material conforms to the interior geometry of the mold cavities to form a dimple pattern on the surface of the ball. The mold cavities may have any suitable dimple arrangement such as, for example, icosahedral, octahedral, cube-octahedral, dipyramid, and the like. The use of various dimple patterns and profiles provides a relatively effective way to modify the aerodynamic characteristics of a golf ball. Suitable dimple patterns include, for example, icosahedron-based pattern, as described in U.S. Pat. No. 4,560,168; octahedral-based dimple patterns as described in U.S. Pat. No. 4,960,281; and tetrahedron-based patterns as described in co-assigned, co-pending, U.S. patent application Ser. No. 12/894,827, the disclosure of which is hereby incorporated by reference. Other tetrahedron-based dimple designs are shown in co-assigned, co-pending design applications Ser. Nos. D 29/362,123; D 29/362,124; D 29/362,125; and D 29/362,126, the disclosures of which are hereby incorporated by reference. Dimple patterns that provide a high percentage of surface coverage are preferred, and are well known in the art. For example, U.S. Pat. Nos. 5,562,552, 5,575,477, 5,957,787, 5,249,804, and 4,925,193 disclose geometric patterns for positioning dimples on a golf ball. In one embodiment, the golf balls of the invention have a dimple coverage of the surface area of the cover of at least about 60 percent, preferably at least about 65 percent, and more preferably at least 70 percent or greater. Dimple patterns having even higher dimple coverage values may also be used with the present invention. Thus, the golf balls of the present invention may have dimple coverage of at least about 75 percent or greater, about 80 percent or greater, or even about 85 percent or greater.

As discussed above, in one version, the balls of this invention have a traditional white-colored cover. In another version, the cover has a non-traditional color such as, for example, red, blue, orange, or yellow. The cover also can be multi-colored. The colored pigments or dyes in the cover layer provide an opaque surface by absorbing the incident light at selective wavelengths. In general, the pigments only absorb certain light wavelengths of the visible spectrum (red, orange, yellow, green, and blue), and the wavelengths, which are not absorbed, are transmitted back to give the appearance of a specific color.

Suitable pigments include nickel and chrome titanates, chrome yellow, cadmium types, carbon black, chrome oxide green types, phthalocyanine blue or green, perylene and quinacridone types, and other conventional pigments. Pigment extenders include, for example, barytes, heavy spar, microtalc, kaolin, micaceous iron oxide, magnesium mica, quartz flour, powdered slate, and silicon carbide. Color flop pigments, as disclosed in Ohira et al, U.S. Pat. Nos. 7,018,307 and 6,558,277, which show a change in color as the viewing angle changes may be used in accordance with the present invention. Edge-effect pigments, which are attracted to the edges or sharper contours of the surfaces to which they are applied, also may be included in the polymer matrix. Likewise, if a fluorescent effect is desired, a relatively small amount of fluorescent dye may be added to the polymer matrix. Suitable fluorescent dyes include, for example, dyes from the thioxanthene, xanthene, perylene, perylene imide, coumarin, thioindigoid, naphthalimide and methine dye classes.

Balls having unique aesthetics also may be made. For example, the outer cover layer may be optically translucent or transparent so that the underlying components of the ball can be seen. More particularly, in one version, the outer cover layer is substantially transparent and the underlying inner cover layer is colored so that the color is visible to a person looking at the exterior of the ball. A sufficient amount of colorant (for example, dyes, pigments, and mixtures thereof) is added to impart the desired color to the underlying layer. The outer and inner cover layers may contain light-reflective fillers, optical brighteners, glitter specks, metallics, particularly metalized films and foils, and the like to provide special decorative effects. Such a colored layer can provide color vibrancy and depth to the substantially transparent surrounding cover layer(s). Thus, a person looking through the substantially transparent cover can see a richly colored background. Different colored inner layers and decorative inserts can be used to create different coloring effects.

The polyurethane and polyurea compositions of this invention provide the golf ball cover with many advantageous properties and features. Particularly, the cover materials have good mechanical strength and cut/shear-resistance as well as light-stability. The polyurethane and polyurea cover materials help enhance the weatherability of the golf balls. It is understood that the golf balls described and illustrated herein represent only presently preferred embodiments of the invention. It is appreciated by those skilled in the art that various changes and additions can be made to such golf balls without departing from the spirit and scope of this invention. It is intended that all such embodiments be covered by the appended claims.

We claim:

1. A method of manufacturing a multi-piece golf ball, comprising the steps of:
providing a golf ball subassembly;
providing a castable composition, the composition comprising a reactive mixture of a polyurethane or polyurea prepolymer and curative blend, the curative blend comprising: i) a curing agent, ii) a freezing point depressing agent, and iii) pigment;
forming a cover layer over the golf ball subassembly by providing first and second mold cavities; dispensing the castable composition into at least one mold cavity, positioning the core in one mold cavity; and mating the mold cavities together.

2. The method of claim 1, wherein the prepolymer is a polyurethane prepolymer formed by reacting: i) a blend of two or more of: isophorone diisocyanate (IPDI), hexamethylene diisocyanate (HDI), 4,4′-dicyclohexylmethane diisocyanate (H₁₂MDI), 4,4′-dicyclohexylmethane diisocyanate (4,4′-MDI), and toluene diisocyanate (TDI), and homopolymers and copolymers thereof, wherein the blend has an average NCO functionality in the range of 2.05 to 2.35; and ii) a polyol compound.

3. The method of claim 2, wherein the blend comprises isophorone diisocyanate (IPDI) and hexamethylene diisocyanate (HDI) homopolymer.

4. The method of claim 2, wherein the blend comprises 4,4′-dicyclohexylmethane diisocyanate (H₁₂MDI) and hexamethylene diisocyanate (HDI) homopolymer.

5. The method of claim 2, wherein the blend comprises 4,4′-dicyclohexylmethane diisocyanate (4,4′-MDI) and toluene diisocyanate (TDI) homopolymer.

6. The method of claim 1, wherein the blend comprises 4,4′-dicyclohexylmethane diisocyanate (4,4′-MDI) and hexamethylene diisocyanate (HDI) homopolymer.

7. The method of claim 1, wherein the prepolymer is a polyurea prepolymer formed by reacting: i) a blend of two or more of: isophorone diisocyanate (IPDI), hexamethylene diisocyanate (HDI), 4,4′-dicyclohexylmethane diisocyanate (H₁₂MDI), 4,4′-dicyclohexylmethane diisocyanate (4,4′-MDI), and toluene diisocyanate (TDI), and homopolymers and copolymers thereof, wherein the blend has an average NCO functionality in the range of 2.05 to 2.35; and ii) a polyamine compound.

8. The method of claim 1, wherein the cover layer comprises polyurethane, polyurea, or hybrid of polyurethane and polyurea.

9. The method of claim 1, wherein the curing agent in the curative blend is a hydroxyl-terminated compound selected from the group consisting of ethylene glycol, diethylene glycol, polyethylene glycol, propylene glycol, polytetramethylene ether glycol, polyethylene propylene glycol, polyoxypropylene glycol, 2-methyl-1,3-propanediol, 1,4-butanediol, 2-methyl-1,4-butanediol, and mixtures thereof.

10. The method of claim 1, wherein the curing agent in the curative blend is an amine-terminated compound selected from the group consisting of 4,4′-diamino-diphenylmethane; 3,5-diethyl-(2,4- or 2,6-) toluenediamine; 3,5-dimethylthio-(2,4- or 2,6-)toluenediamine; 3,5-diethylthio-(2,4- or 2,6-) toluenediamine: 2,2′-dichloro-3,3′,5,5′-tetraethyl-4,4′-diamino-diphenylmethane; polytetramethyleneglycol-di(p-aminobenzoate); 4,4′-bis(sec-butylamino)-dicyclohexylmethane; and mixtures thereof.

11. The method of claim 1, wherein the pigment in the curative blend is selected from the group consisting of titanium dioxide; red or yellow iron oxides; carbon black; ultramarine blue; phthalocyanine blue; phthalocyanine green; carbazole violets; and naphthol reds; and mixtures thereof.

12. The method of claim 1, wherein the freezing point depressing agent in the curative blend is a hydroxyl-terminated compound selected from the group consisting of 1,3-propanediol; 2-methyl-1,3-propanediol; 2-methyl-1,4-butanediol; 1,2-butanediol; 1,3-butanediol; ethylene glycol; diethylene glycol; 1,5-pentanediol; polytetramethylene glycol; propylene glycol; dipropylene glycol; and mixtures thereof.

13. The method of claim 1, wherein the freezing point depressing agent in the curative blend is an amine-terminated compound selected from the group consisting of hexamethylene diamine; diethanolamine; triethanol amine; diisopropanolamine; and triisopropanolamine.

14. The method of claim 1, wherein the cover layer has a thickness of about 0.015 to about 0.090 inches and material hardness in the range of about 40 to about 65 Shore D.

15. The method of claim 1, wherein the golf ball subassembly is a single piece core, the core comprising a polybutadiene rubber composition.

16. The method of claim 15, wherein the core has a diameter of about 1.26 to about 1.60 inches and surface hardness in the range of about 30 to about 65 Shore D.

17. The method of claim 1, wherein the golf ball subassembly is dual-core having an inner core and outer core layer, and wherein at least one of the core layers comprises a polybutadiene rubber composition.

18. The method of claim 1, wherein the golf ball subassembly comprises a core and intermediate layer disposed about the core.

19. The method of claim 18, wherein the intermediate layer comprises ethylene acid copolymer ionomer.

20. The method of claim 16, wherein the intermediate layer has a thickness of about 0.015 to about 0.120 inches and surface hardness in the range of about 45 to about 75 Shore D.
